(19) United States
(12) Patent Application Publication
(10) Pub. No.: US 2016/0237964 A1
(43) Pub. Date: Aug. 18, 2016

(54) HEAT TRANSFER SYSTEM AND METHOD OF MAKING AND USING THE SAME

(71) Applicant: BorgWarner Inc., Auburn Hills, MI (US)

(72) Inventor: Frederick M. Huscher, Hendersonville, NC (US)

(21) Appl. No.: 15/007,536

(22) Filed: Jan. 27, 2016

Related U.S. Application Data
(60) Provisional application No. 62/116,772, filed on Feb. 16, 2015.

(51) Int. Cl. F02M 37/04; H02K 9/14; H02K 5/16; H02K 9/19

(52) U.S. Cl. CPC F02M 37/04; H02K 9/19; H02K 9/14; H02K 5/16

(57) ABSTRACT

One variation includes a generator comprising a housing, at least one shaft, at least one bearing, and at least one fluid system comprising a pump, a fluid, and a fluid jacket, wherein the fluid system is constructed and arranged for transferring heat from at least one of the bearing or the housing to the fluid. One variation includes a fluid circuit comprising a fluid, a condenser, a generator/expander, a pump, at least one valve, and an injection path constructed and arranged to deliver fluid from the fluid circuit into a fuel injection mixture for an engine.

### CROSS-REFERENCE TO RELATED APPLICATIONS

This application claims the benefit of U.S. Provisional Application No. 62/116,772 filed Feb. 16, 2015.

### TECHNICAL FIELD

The field to which the disclosure generally relates to includes heat transfer systems and methods of making and using the same.

### BACKGROUND

In a number of variations, there are components in heat transfer systems for transferring heat.

A Rankine cycle is a model used to predict the performance of a heat engine, in which a working fluid may be directed to a boiler or heat exchanger where it is evaporated. The evaporated fluid may then be passed through an expansion device (turbine, generator or other expander) in which work may be performed by the evaporated fluid on the expansion device, and then may be passed through a condenser where it may be re-condensed. In a final step, a pump may be used to return the liquefied working fluid to the boiler or heat exchanger. In a Rankine cycle, heat may be converted into useful work that can itself be converted into electricity.

An organic Rankine cycle (ORC) is named for its use of an organic, high molecular mass working fluid with a liquid-vapor phase-change, occurring at a lower temperature than the water-steam phase change. When used in a Rankine cycle system, the organic, high molecular mass working fluid may allow waste heat recovery from lower temperature sources such as biomass combustion, industrial waste heat, geothermal heat, or may be another source. An ORC system is ideally suited to recover energy from waste heat generated in a vehicle, where it is estimated that for each drop of fuel, only forty to fifty percent of the fuel energy is delivered to the power train, and the remainder is waste heat. The waste heat is typically lost to the environment via the vehicle exhaust, the radiator that cools the engine, and other pathways.

### SUMMARY OF ILLUSTRATIVE VARIATIONS

A number of variations may include a product comprising a generator comprising a housing, at least one shaft, at least one bearing, and at least one fluid system comprising a pump, a fluid, and a fluid jacket, wherein the fluid system may be constructed and arranged for transferring heat between at least one of the bearing or the housing and the fluid.

A number of variations may include a product comprising a fluid circuit comprising a fluid, a condenser, a generator/expander, a pump, at least one valve, and an injection path constructed and arranged to deliver fluid from the fluid circuit into a fuel injection mixture for an engine.

A number of variations, may include a method comprising providing a fluid circuit comprising a fluid, at least one pump, a condenser, a turbine, a generator, a heat exchanger, and an injection path constructed and arranged to deliver fluid from the fluid circuit into a fuel injection mixture for an engine; and flowing fluid through the fluid circuit wherein fluid may be allowed into the injection path by operation of a controller constructed to allow fluid into the fluid path based on at least one variable comprising at least one of fluid temperature, fluid pressure, engine load, engine speed, engine temperature, intake temperature, intake density, or exhaust temperature.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a product according to a number of variations.

FIG. 2 is a product according to a number of variations.

FIG. 3 is a method according to a number of variations.

### DETAILED DESCRIPTION OF ILLUSTRATIVE VARIATIONS

The following description of the variations is merely illustrative in nature and is in no way intended to limit the scope of the invention, its application, or uses.

As used throughout the specification, the phrases “about” and “at or about” are intended to mean that the amount or value in question may be the value designated or some other value about the same. The phrase is intended to convey that similar values promote equivalent results or effects according to the invention.

In a number of variations, ORC systems may be used to improve the fuel efficiency of vehicle engines, for example, tractor-trailers that are used for long-haul commercial trucking. In a vehicle, an ORC system may use waste heat from the engine to boil or engage in heat transfer with a working fluid. This fluid may be expanded within the thermodynamic cycle to create useful power. In a number of variations, the expansion device may be a turbine in which the working fluid performs work on a turbine wheel connected to a shaft. By connecting the shaft to a generator, the waste heat may be converted to electric power that may be stored or used by the vehicle in other ancillary systems. The working fluid may then be condensed and returned to the boiler or heat exchanger via a pump.

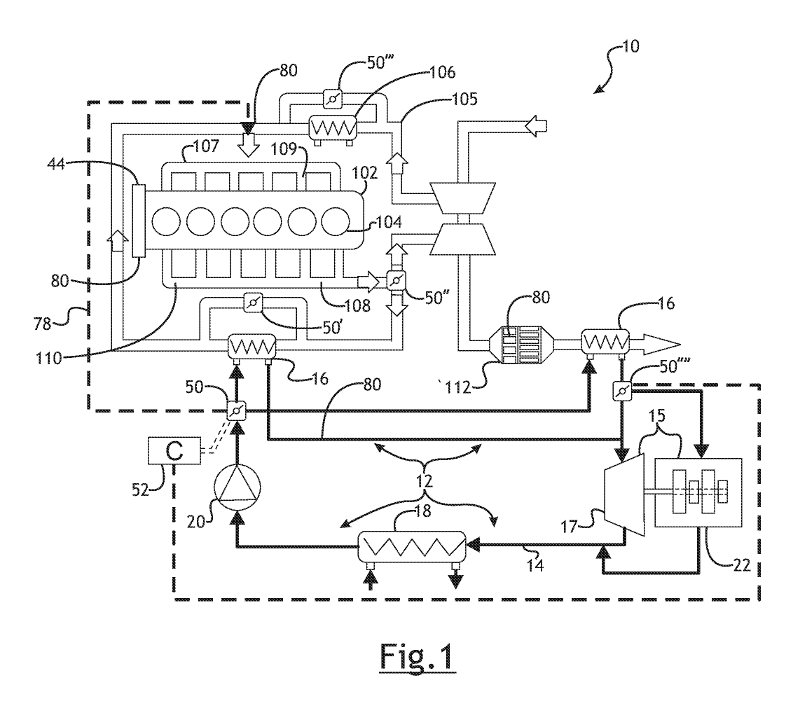

A product 10 is shown in FIG. 1 according to a number of variations. In a number of variations, the product 10 may include a heat transfer system 11. In a number of variations, the product 10 includes a fluid circuit 12. In a number of variations, the fluid circuit 12 may include a working fluid 14. In a number of variations, the working fluid 14 may include at least one of ethanol, methanol, kerosene, gasoline, diesel, propanol, butanol, water, benzene, toluene, methane, ethane, propane, butane, acetone, or liquid hydrogen. In a number of variations, the working fluid 14 may undergo a plurality of phase changes throughout the fluid circuit to produce a heat transfer from or to the fluid 14 from surrounding components to bring the fluid 14 from a high temperature state to a low temperature state or vice versa, which may be converted into useful work, which may be converted into electrical, chemical, or mechanical energy. In a number of variations, the fluid circuit 12 may be a Rankine cycle. In a number of variations, the fluid circuit 12 may be an organic Rankine cycle. In a number of variations, the fluid circuit 12 may be a Kalina cycle. In a number of variations, the fluid circuit 12 may be a part of a vehicle including, but not limited to, a motor vehicle, a spacecraft, a watercraft, an aircraft, a train, or may be another type.

Referring to FIG. 1, in a number of variations, the fluid circuit 12 may include at least one heat exchanger 16 to transfer heat to or from the fluid 14 from or to an exhaust stream 108. In a number of variations, the heat exchanger 16 may be a heat exchanger type including, but not limited to an electric heating, a double pipe, a shell and tube, a plate heat, a plate and shell, an adiabatic wheel, a plate fin heat, a pillow plate, or a fluid heat exchanger or may be another type. In a number of variations, the heat exchanger 16 may evaporate the fluid 14. In a number of variations, the heat exchanger 16 may include a boiler which may allow the fluid to undergo a phase change from liquid to gas. In a number of variations, the fluid circuit 12 may include a generator/expander 15. In a number of variations, the generator/expander 15 may include an expander 17. In a number of variations, the generator/expander 15 may include a generator 22. In a number of variations, the generator/expander 15 may allow for work to be performed by the evaporated fluid 14 on the expander 17, or to convert thermal energy into mechanical work which may be converted into electrical power by the generator 22. In a number of variations, the fluid circuit 12 may include a condenser 18 which may condense the fluid 14 from a gas to a liquid, and may include may include at least one heat exchanger to transfer heat to or from the fluid 14 from or to an exhaust stream 108, air intake stream 105, or may be another stream. In a number of variations, the condenser 18 may be a heat exchanger including, but not limited to an electric heating, a double pipe, a shell and tube, a plate heat, a plate and shell, an adiabatic wheel, a plate fin heat, a pillow plate, or a fluid heat exchanger or may be another type. In a number of variations, the fluid circuit 12 may include at least one pump 20 which may move the fluid 14 through the fluid circuit 12. In a number of variations, the pump 20 may be a rotary positive displacement pump, a reciprocating positive displacement pump, a gear pump, a screw pump, a progressing cavity pump, a roots-type pump, a peristaltic pump, a plunger pump, a rope pump, a impeller pump, a hydraulic ram pump, a radial-flow pump, an axial-flow pump, a mixed-flow pump, an eductor-jet pump, a steam pump, a gravity pump, a valveless pump, or may be another type. In a number of variations, the pump 20 may pressurize the fluid 14 as a liquid or a gas. In a number of variations, the fluid circuit 12 may include a high pressure pump 20A, a low pressure pump 20B, or both. In a number of variations, the fluid circuit 12 may include a high pressure pump 20A, a low pressure pump 20B, or both. In a number of variations, the pump 20 may include either the high pressure pump 20A, or the low pressure pump 20B. In a number of variations, the fluid 14 may be an organic, high molecular mass working fluid with a liquid-vapor phase-change that may occur at a low temperature. In a number of variations, the fluid circuit 12 may allow for waste heat recovery from other sources in contact with the fluid 14, such as, but not limited to, exothermal processes using combustion heat, industrial waste heat, geothermal heat, or may be another type. In a number of variations, the fluid circuit 12 may recover energy from waste heat in a vehicle from areas including, but not limited to, a vehicle exhaust, a radiator, or may be another type. In a number of variations, the expander 17 may include a turbine, expander, or may be another type. In a number of variations, the fluid circuit 12 may include an injection path 78, which may be constructed and arranged to deliver fluid 14 from the fluid circuit 12 into a fuel injection mixture for an engine 44. In a number of variations, the engine 44 may be an internal or external combustion engine including, but not limited to, compression or spark ignited engines. In a number of variations, the engine 44 may be an engine 44 of a vehicle. In a number of variations, the engine 44 may include an engine head 102 and an engine block 104. In a number of variations, input air 105 may be brought into the engine 44 from the environment and put through a charge air cooler 106 then put into the engine through an intake manifold 107. In a number of variations, the air may mix with a fuel to form a fuel injection mixture inlet 109. In a number of variations, the air/fuel mix may be optimized to allow for maximum efficient engine 44 conditions including, but not limited to, reduced cooler intake charge, increased fuel injection mixture combustibility, and reduced emissions. In a number of variations, the fluid 14 in the injection path 78 may be added to the fuel injection mixture to further optimize the efficiency of the engine 44. In a number of variations, this may increase fuel economy and reduce engine 44 emissions. In a number of variations, the fluid circuit 12 may also result in increased engine 44 power, reduced fuel consumption, and lower exhaust emissions. In a number of variations, the system may allow for increased packaging flexibility and minimal incremental cost of installation. In a number of variations, the injection path 78 may include at least one injector 80 for injection of the fluid 14 into the fuel injection mixture for an engine 44. In a number of variations, the injector 80 may be located along, adjacent to, in, or near the engine intake manifold 107. In a number of variations, the injector 80 may be located along, adjacent to, in or near a different location of the fuel injection mixture inlet 109 for the engine 44. In a number of variations, the fluid circuit 12 may include a valve 50 for controlling how fluid 14 leaves the fluid circuit 12 and enters the injection path 78. In a number of variations, the valve 50 may be controlled by a controller 52 to control the amount of fluid into the injection path 78. In a number of variations, the valve 50 may be at least one of a ball valve, a butterfly valve, a ceramic disc valve, a check valve, a choke valve, a diaphragm valve, a gate valve, a globe valve, a knife valve, a needle valve, a pinch valve, a piston valve, a plug valve, a poppet valve, a spool valve, a thermal expansion valve, a pressure reducing valve, a sampling valve, a safety valve, or may be another type. In a number of variations, the controller 52 may control the amount of fluid 14 into the injection path 78 according to at least one variable measured by at least one sensor 80 in the fluid circuit 30 or engine 44 or other vehicle component, which may include at least one of fluid 14 temperature, fluid 14 pressure, engine 44 load, engine 44 speed, engine 44 temperature, intake fuel injection mixture temperature, intake fuel injection mixture density, or exhaust temperature, or engine operating condition. In a number of variations, the engine 44 may include an exhaust outlet fluid or exhaust 108. In a number of variations, the exhaust 108 may flow through an exhaust manifold 110. In a number of variations, the exhaust outlet 108 may be at an internal temperature and may be put into at least one heat exchanger 16 which may be part of the fluid circuit 12 to transfer heat to the fluid 14. In a number of variations, the exhaust 108 may be further treated through an exhaust air treatment system 112. In a number of variations, the exhaust 108 may be put into a plurality of heat exchangers 16, 16′ which may be part of the fluid circuit 12 to transfer heat to the fluid 14. In a number of variations, at least a portion of the exhaust 108 may be recycled back to the fuel injection mixture inlet 109. In a number of variations, additional valves 50, 50′, 50″, 50′″ may be located in the flow of air intake stream 105, exhaust stream 108, or another location. In a number of variations, a number of components (16, 50, 52, 20, 18, 17, 15, 22, 16, 80) of the fluid circuit 12 may be rearranged in location or flow direction of fluid 14 and are not limited to the embodiment shown in FIG. 1 and may have more or fewer components. In a number of variations, the fluid circuit 12 may include further heat exchange components for the fluid 14 including, but not limited to, a radiator, an axle oil heat exchanger, an engine oil heat exchanger, a cabin heater, or may be another type.

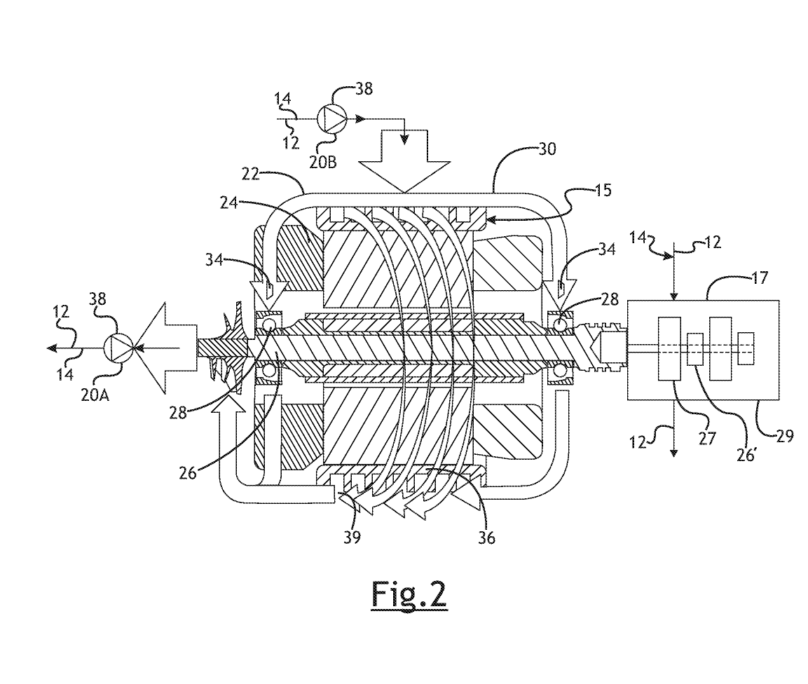

In a number of variations, the generator/expander 15 may convert the heat of the fluid 14 into useful work through a generator 22. In a number of variations, the generator 22 may be a dynamo or an alternator. In a number of variations, the generator may rotate at speeds from 1000-200,000 RPM, and may produce power in the range of 5-1000 kilowatts. In a number of variations, the generator 22 may include a rotor shaft 26, and/or a stator 27. In a number of variations, the generator 22 may include an armature (not shown) which may generate electric current to be collected by an electric collection component (not shown). In a number of variations, the electric current may be used to power an engine 44 or other component of a vehicle. In a number of variations, the electric current may be stored in a battery (not shown). In a number of variations, the generator 22 may include a magnetic field (not shown), which may be provided by magnets or electromagnets mounted on either the rotor 26 or the stator 27. In a number of variations, the generator/expander 15 may include an expander 17 that may include a turbine 29, which may be attached to or may have in common a rotor shaft 26 of the generator 22 and may be used to drive the generator 22 to produce electric current. In a number of variations, fluid 14 may flow through the turbine 29 to rotate the rotor 26. In a number of variations, the turbine 29 may be at least one of a steam turbine, a gas turbine, a transonic turbine, a contra-rotating turbine, a statorless turbine, a shrouded turbine, a ceramic turbine, a shroudless turbine, a bladless turbine, a water turbine (including Pelton, Francis, Kaplan, Turgo, or Cross-flow), a pressure compound turbine, or may be another type. In a number of variations, the turbine 29 may have at least one rotor 26′ and at least one stator 27′. In a number of variations, the turbine 29 may be an impulse turbine or a reaction turbine. As shown in FIG. 2, in a number of variations, the generator 22 may include a housing 24, at least one shaft 26, at least one bearing 28, and at least one fluid system 30 comprising a generator pump 20B, 20A, a fluid 14 and a fluid jacket 36, wherein the fluid system 30 may be constructed and arranged for transferring heat from at least one of the bearing 28 or the housing 24 to the fluid 14. In a number of variations, the fluid system 30 may also be constructed and arranged to lubricate the at least one bearing 28. In a number of variations, the fluid system may include a nozzle 34 for injecting the fluid 14 into the bearing 28. In a number of variations, the bearing 28 may be a plain bearing, rolling-element bearing, jewel bearing, fluid bearing, magnetic bearing, or flexure bearing, or may be another type. In a number of variations, the fluid system 30 may be directly connected to the fluid circuit 12. In a number of variations, the generator pump 38 may be a part of, or may encompass, the pump 20, the high pressure pump 20A, or the low pressure pump 20B of the fluid circuit 12. In a number of variations, the generator pump 38 may flow fluid through the fluid jacket 36, bearing 28 or both or neither. In a number of variations, the fluid jacket 36 may surround the housing 24 of the generator 22. In a number of variations, the fluid system 30 may transfer heat from the fluid jacket 36 to the housing 24 or may transfer heat from at least one of the housing 24, stator 27, or rotor 26, to the fluid jacket 36. In a number of variations, the fluid system 30 may transfer heat from the fluid jacket 36 to the fluid 14. In a number of variations, the fluid system 30 may transfer heat from the bearing 28 to the fluid 14 or may transfer heat from the fluid 14 to the bearing 28. In a number of variations, the fluid 14 may collect at a fluid reservoir 39 at the base of the fluid jacket 36 after flowing through the jacket 36 and bearing 28. In a number of variations, heat transfer from the bearing 28, stator 27, rotor 26, housing 24, fluid jacket 36, or fluid system 30 to the fluid 14 may increase cycle thermal efficiency by preheating the fluid before it enters the engine 44. In a number of variations, the fluid 14 may then flow through the pump 20, 20A and back into the fluid circuit 12. In a number of variations, fluid 14 may also flow through the expander 17, and/or turbine 29 in the fluid circuit 12. In a number of variations, a valve 50″″ may split fluid flow between the fluid system 30 and the expander 17. In a number of variations, the valve 50″″ may be controlled by the controller 52 and may split fluid at a ratio based on at least one variable. In a number of variations, the fluid system 30 may allow for recapture of waste heat from an engine 44, exhaust 108, or generator/expander 15. In a number of variations, power electronics may be packed with the generator/expander 15 and fluid system 30 to allow for cooling of the electronics. In a number of variations, the generator/expander 15 and fluid system 30 may be allowed to be packed adjacent to or on the engine 44, which may allow for increased system packaging flexibility and minimal resource use and thermal inefficiency. In a number of variations, a number of components (22, 38, 24, 34, 28, 20A, 20B, 12, 17, 29, 14, 36, 39, 34) of the fluid circuit 12 may be rearranged in location or flow direction of fluid 14 and are not limited to the embodiment shown in FIG. 2 and may have more or fewer components.

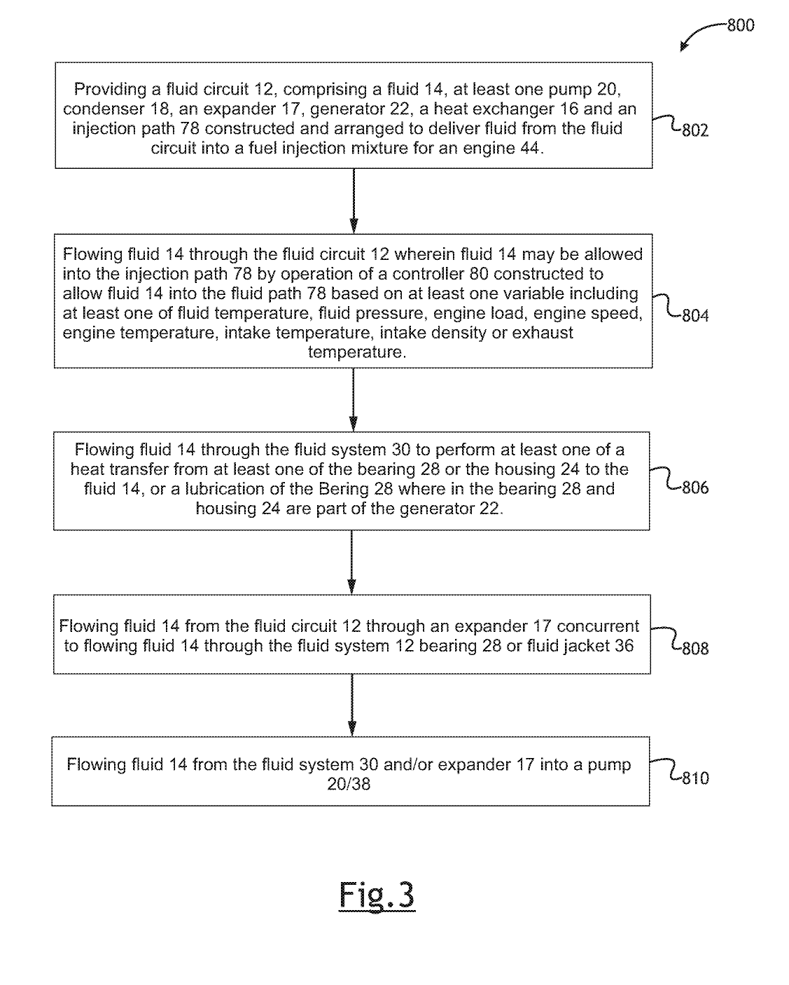

In a number of variations, as shown in FIG. 3, a method 800 is shown. In a number of variations, the method 800 may include a step 802 of providing a fluid circuit 12 comprising a fluid 14, at least one pump 20, a condenser 18, a expander 17, a generator 22, a heat exchanger 16, and an injection path 78 constructed and arranged to deliver fluid 14 from the fluid circuit 12 into a fuel injection mixture for an engine 44. In a number of variations, the method 800 further includes step 804 of flowing fluid 14 through the fluid circuit 12 wherein fluid 14 may be allowed into the injection path 78 by operation of a controller 80 constructed to allow fluid 14 into the fluid path 78 based on at least one variable including at least one of fluid temperature, fluid pressure, engine load, engine speed, engine temperature, intake temperature, intake density, or exhaust temperature. In a number of variations, the generator 22 further includes a housing 24, at least one shaft 26, at least one bearing 28, and at least one fluid system 30 comprising a pump 20, a fluid 14 and a fluid jacket 36, wherein the fluid system 30 constructed and arranged for transferring heat from at least one of the bearing 28 or the housing 24 to the fluid 14. In a number of variations, the method 800 may further include step 806 of flowing fluid 14 through the fluid system 30 to perform at least one of a heat transfer from at least one of the bearing 28 or the housing 24 to the fluid 14, or a lubrication of the bearing 28. In a number of variations, the method 800 may further include step 808 of flowing fluid 14 from the fluid circuit 12 through an expander 17 concurrent to flowing fluid 14 through the fluid system 12 bearing 28 or fluid jacket 36. In a number of variations, the method 800 may further include step 810 of flowing fluid 14 from the fluid system 30 and/or expander 17 into a pump 20.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a generator comprising a housing, at least one shaft, at least one bearing, and at least one fluid system comprising a pump, a fluid, and a fluid jacket, wherein the fluid system is constructed and arranged for transferring heat between at least one of the bearing or the housing and the fluid.

Variation 2 may include a product as set forth in Variation 1 wherein the fluid system is also constructed and arranged to lubricate the bearing.

Variation 3 may include a product as set forth in any of Variations 1-2 wherein the fluid comprises at least one of ethanol, methanol, kerosene, gasoline, diesel, propanol, butanol, water, benzene, toluene, methane, ethane, propane, butane, acetone, or liquid hydrogen.

Variation 4 may include a product as set forth in any of Variations 1-3 wherein the pump flows fluid directly through the bearing.

Variation 5 may include a product as set forth in any of Variations 1-4 wherein the product further comprises a fluid turbine for generating power in the generator.

Variation 6 may include a product as set forth in any of Variations 1-5 wherein the product further comprises a fluid circuit further comprising at least one of a condenser or a heat exchanger.

Variation 7 may include a product as set forth in any of Variations 1-6 wherein the fluid system further comprises at least one nozzle for injection of fluid into the bearing.

Variation 8 may include a product including a fluid circuit comprising a fluid, a condenser, a generator/expander, a pump, at least one valve, and an injection path constructed and arranged to deliver fluid from the fluid circuit into a fuel injection mixture for an engine.

Variation 9 may include a product as set forth in any of Variation 8 wherein the injection path comprises an injector.

Variation 10 may include a product as set forth in any of Variations 8-9 wherein the fluid comprises at least one of ethanol, methanol, kerosene, gasoline, diesel, propanol, butanol, water, benzene, toluene, methane, ethane, propane, butane, acetone, or liquid hydrogen.

Variation 11 may include a product as set forth in any of Variations 8-10 wherein the fluid circuit further comprises a controller constructed and arranged to control the amount of fluid into the injection path according to a variable comprising at least one of, fluid temperature, fluid pressure, engine load, engine speed, engine temperature, intake temperature, intake density, or exhaust temperature.

Variation 12 may include a product as set forth in Variations 8-11 wherein the engine comprises an internal combustion engine for a vehicle.

Variation 13 may include a product as set forth in and of Variations 8-12 wherein the injector is located adjacent to, in, or near an intake manifold of the engine.

Variation 14 may include a method including providing a fluid circuit comprising a fluid, at least one pump, a condenser, a turbine, a generator, a heat exchanger, and an injection path constructed and arranged to deliver fluid from the fluid circuit into a fuel injection mixture for an engine; and flowing fluid through the fluid circuit wherein fluid is allowed into the injection path by operation of a controller constructed to allow fluid into the fluid path based on at least one variable comprising at least one of fluid temperature, fluid pressure, engine load, engine speed, engine temperature, intake temperature, intake density, or exhaust temperature.

Variation 15 may include a method as set forth in Variation 14 wherein the injection path comprises an injector.

Variation 16 may include a method as set forth in any of Variations 14-15 wherein the generator comprises a housing, at least one shaft, at least one bearing, and at least one fluid system comprising a pump, a fluid and a fluid jacket, wherein the fluid system constructed and arranged for transferring heat between at least one of the bearing or the housing and the fluid.

Variation 17 may include a method as set forth in any of Variations 14-16 wherein the method further includes flowing fluid through the fluid system to perform at least one of a heat transfer between at least one of the bearing or the housing and the fluid, or a lubrication of the bearing.

Variation 18 may include a method as set forth in any of Variations 14-17 wherein the engine comprises an internal combustion engine for a vehicle.

Variation 19 may include a method as set forth in any of Variations 14-18 wherein the injector is located adjacent to, in, or near an intake manifold of the engine.

Variation 20 may include a method as set forth in any of Variations 14-19 wherein the fluid comprises at least one of ethanol, methanol, kerosene, gasoline, diesel, propanol, butanol, water, benzene, toluene, methane, ethane, propane, butane, acetone, or liquid hydrogen.

Variation 21 may include a product as set forth in any of Variations 1-20 wherein the fluid circuit is a Kalina cycle.

Variation 22 may include a product or method as set forth in any of Variations 1-21 wherein the fluid circuit is a part of a vehicle including, but not limited to, a motor vehicle, a spacecraft, a watercraft, an aircraft, or a train.

Variation 23 may include a product or method as set forth in any of Variations 1-22 wherein the heat exchanger is a heat exchanger type including, but not limited to an electric heating, a double pipe, a shell and tube, a plate heat, a plate and shell, an adiabatic wheel, a plate fin heat, a pillow plate, or a fluid heat exchanger.

Variation 24 may include a product or method as set forth in any of Variations 1-23 wherein the condenser is a heat exchanger including, but not limited to an electric heating, a double pipe, a shell and tube, a plate heat, a plate and shell, an adiabatic wheel, a plate fin heat, a pillow plate, or a fluid heat exchanger.

Variation 25 may include a product or method as set forth in any of Variations 1-24 the pump is a rotary positive displacement pump, a reciprocating positive displacement pump, a gear pump, a screw pump, a progressing cavity pump, a roots-type pump, a peristaltic pump, a plunger pump, a rope pump, a impeller pump, a hydraulic ram pump, a radial-flow pump, an axial-flow pump, a mixed-flow pump, an eductor-jet pump, a steam pump, a gravity pump, or a valveless pump.

Variation 26 may include a product or method as set forth in any of Variations 1-25 wherein the engine is an internal or external combustion engine.

Variation 27 may include a product or method as set forth in any of Variations 1-26 wherein the fluid circuit recovers energy from waste heat in a vehicle from areas including, but not limited to, a vehicle exhaust, or a radiator.

Variation 28 may include a product or method as set forth in any of Variations 1-27 wherein the engine comprises an engine head and an engine block.

Variation 29 may include a product or method as set forth in any of Variations 1-28 wherein the fluid in the injection path is added to the fuel injection mixture to further optimize the efficiency of the engine by injection into the intake manifold.

Variation 30 may include a product or method as set forth in any of Variations 1-29 wherein the injector is located along, adjacent to, in, or near an engine intake manifold.

Variation 31 may include a product or method as set forth in any of Variations 1-30 wherein the fluid circuit comprises a valve for controlling how fluid leaves the fluid circuit and enters the injection path.

Variation 32 may include a product or method as set forth in any of Variations 1-31 wherein the valve is controlled by a controller to control the amount of fluid into the injection path.

Variation 33 may include a product or method as set forth in any of Variations 1-32 wherein the valve is at least one of a ball valve, a butterfly valve, a ceramic disc valve, a check valve, a choke valve, a diaphragm valve, a gate valve, a globe valve, a knife valve, a needle valve, a pinch valve, a piston valve, a plug valve, a poppet valve, a spool valve, a thermal expansion valve, a pressure reducing valve, a sampling valve, or a safety valve.

Variation 34 may include a product or method as set forth in any of Variations 1-33 wherein the engine includes an exhaust that is treated through an exhaust air treatment system.

Variation 35 may include a product or method as set forth in any of Variations 1-34 wherein the exhaust is put into a plurality of heat exchangers which are part of the fluid circuit to transfer heat to the fluid.

Variation 36 may include a product or method as set forth in any of Variations 1-35 wherein the fluid circuit includes further heat exchange components for the fluid comprising at least one of, a radiator, an axle oil heat exchanger, an engine oil heat exchanger, or a cabin heater.

Variation 37 may include a product or method as set forth in any of Variations 1-36 wherein the generator is a dynamo or an alternator.

Variation 38 may include a product or method as set forth in any of Variations 1-37 wherein the generator includes at least one of a rotor shaft or a stator.

Variation 39 may include a product or method as set forth in any of Variations 1-38 wherein turbine is at least one of a steam turbine, a gas turbine, a transonic turbine, a contra-rotating turbine, a statorless turbine, a shrouded turbine, a ceramic turbine, a shroudless turbine, a bladless turbine, a water turbine (including Pelton, Francis, Kaplan, Turgo, or Cross-flow), or a pressure compound turbine.

Variation 40 may include a product or method as set forth in any of Variations 1-39 wherein the turbine is at least one of an impulse turbine or a reaction turbine.

Variation 41 may include a product or method as set forth in any of Variations 1-40 wherein the bearing is at least one of a plain bearing, rolling-element bearing, jewel bearing, fluid bearing, magnetic bearing, or flexure bearing.

Variation 42 may include a product or method as set forth in any of Variations 1-41 wherein the fluid of the fluid system collects at a fluid reservoir at the base of the fluid jacket after flowing through the jacket and bearing.

Variation 43 may include a product or method as set forth in any of Variations 1-42 wherein a valve 50 splits fluid flow between the fluid system and the expander and is controlled by the controller.

Variation 44 may include a product or method as set forth in any of Variations 1-43 wherein the method further includes flowing fluid from the fluid system through an expander concurrent to flowing fluid through the fluid system bearing or fluid jacket.

Variation 45 may include a product or method as set forth in any of Variations 1-44 wherein the method further includes flowing fluid from the fluid system or expander into a pump.

The above description of select variations within the scope of the invention is merely illustrative in nature and, thus, variations or variants thereof are not to be regarded as a departure from the spirit and scope of the invention.

What is claimed is:

1. A product comprising: a generator comprising a housing, at least one shaft, at least one bearing, and at least one fluid system comprising a pump, a fluid, and a fluid jacket, wherein the fluid system is constructed and arranged for transferring heat between at least one of the bearing or the housing and the fluid.

2. A product as set forth in claim 1 wherein the fluid system is also constructed and arranged to lubricate the bearing.

3. A product as set forth in claim 1 wherein the fluid comprises at least one of ethanol, methanol, kerosene, gasoline, diesel, propanol, butanol, water, benzene, toluene, methane, ethane, propane, butane, acetone, or liquid hydrogen.

4. A product as set forth in claim 1 wherein the pump flows fluid directly through the bearing.

5. A product as set forth in claim 1 wherein the product further comprises a turbine for generating power in the generator.

6. A product as set forth in claim 1 wherein the product further comprises a fluid circuit further comprising at least one of a condenser or a heat exchanger.

7. A product as set forth in claim 1 wherein the fluid system further comprises at least one nozzle for injection of fluid into the bearing.

8. A product comprising: a fluid circuit comprising a fluid, a condenser, a generator/expander, a pump, at least one valve, and an injection path constructed and arranged to deliver fluid from the fluid circuit into a fuel injection mixture for an engine.

9. A product as set forth in claim 8 wherein the injection path comprises an injector.

10. A product as set forth in claim 8 wherein the fluid comprises at least one of ethanol, methanol, kerosene, gasoline, diesel, propanol, butanol, water, benzene, toluene, methane, ethane, propane, butane, acetone, or liquid hydrogen.

11. A product as set forth in claim 8 wherein the fluid circuit further comprises a controller constructed and arranged to control the amount of fluid into the injection path according to a variable comprising at least one of, fluid temperature, fluid pressure, engine load, engine speed, engine temperature, intake temperature, intake density, or exhaust temperature.

12. A product as set forth in claim 8 wherein the engine comprises an internal combustion engine for a vehicle.

13. A product as set forth in claim 8 wherein the injector is located adjacent to, in, or near an intake manifold of the engine.

14. A method comprising:
providing a fluid circuit comprising a fluid, at least one pump, a condenser, a turbine, a generator, a heat exchanger, and an injection path constructed and arranged to deliver fluid from the fluid circuit into a fuel injection mixture for an engine; and
flowing fluid through the fluid circuit wherein fluid is allowed into the injection path by operation of a controller constructed to allow fluid into the fluid path based on at least one variable comprising at least one of fluid temperature, fluid pressure, engine load, engine speed, engine temperature, intake temperature, intake density, or exhaust temperature.

15. A method as set forth in claim 14 wherein the injection path comprises an injector.

16. A method as set forth in claim 14 wherein the generator comprises a housing, at least one shaft, at least one bearing, and at least one fluid system comprising a pump, a fluid and a fluid jacket, wherein the fluid system constructed and arranged for transferring heat between at least one of the bearing or the housing and the fluid.

17. A method as set forth in claim 14 wherein the method further includes flowing fluid through the fluid system to perform at least one of a heat transfer between at least one of the bearing or the housing and the fluid, or a lubrication of the bearing.

18. A method as set forth in claim 14 wherein the engine comprises an internal combustion engine for a vehicle.

19. A method as set forth in claim 14 wherein the injector is located adjacent to, in, or near an intake manifold of the engine.

20. A method as set forth in claim 14 wherein the fluid comprises at least one of ethanol, methanol, kerosene, gasoline, diesel, propanol, butanol, water, benzene, toluene, methane, ethane, propane, butane, acetone, or liquid hydrogen.
